(19) United States
(12) Patent Application Publication
(10) Pub. No.: US 2009/0061376 A1
(43) Pub. Date: Mar. 5, 2009

(54) Self-Locking Orthodontic Bracket

(76) Inventor: Arthur L. Wool, Wyomissing, PA (US)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/198,244

(22) Filed: Aug. 26, 2008

Related U.S. Application Data
(60) Provisional application No. 60/968,959, filed on Aug. 30, 2007.

(51) Int. Cl. A61C 7/12

(52) U.S. Cl. 433/11

(57) ABSTRACT

An orthodontic bracket includes a bracket body having a mesial-distally extending archwire slot opening to the labial surface portion, and a mesial-distally extending groove provided adjacent the archwire slot in a portion of the bracket body labially and occlusally of the archwire slot, the groove opening in a gingival direction. A spring clip of resilient material has labial and lingual portions in embracing sliding engagement with corresponding labial and lingual surface portions of the body, the spring clip being movable on the bracket body between an open position in which the archwire slot is open to the labial surface portion and a closed position in which the archwire slot is closed by the spring clip to the labial surface portion. The labial portion of the spring clip terminates in a free end that, in the closed position, is retained in the groove in the bracket body. The groove substantially prevents movement of the spring clip in the labial direction when in the closed position and is provided in relation to the archwire slot such that, when an archwire is provided in the archwire slot and is in contact with a lingual surface of the archwire slot, the spring clip is not in contact with the archwire.

### CROSS-REFERENCE TO RELATED APPLICATION

This application is a nonprovisional application of US Provisional Application Ser. No. 60/968,959, filed Aug. 30, 2007, the contents of which are incorporated herein by reference.

### BACKGROUND OF THE INVENTION

Orthodontic brackets having a base and a slot for receiving an archwire are well known in the orthodontic field. Typically, the brackets are attached to respective teeth or to base plates bonded to the teeth. The brackets are attached to the teeth so that they have an orientation with respect to each tooth and with respect to each other determined by the orthodontist in a manner designed to correct the malposition of a tooth or teeth by the treatment.

In order to correct the malposition of a tooth or teeth, an archwire is inserted into the archwire slots of the brackets. The archwire exerts a torque on selected brackets, determined in part by the positioning of the brackets on the teeth, to gradually move the teeth into proper position.

In order to hold the archwire within the archwire slots of the brackets, it is known to use twisted wire ligatures or elastomeric O-rings on each bracket. In order to simplify the removal and securing of archwires in the brackets over the course of the treatment, it has been proposed to provide self-locking brackets, thereby avoiding the need for ligatures or elastomeric O-rings. Examples of previous attempts to provide self-locking brackets can be found in U.S. Pat. No. 5,275,557 to Damon, U.S. Pat. No. 5,630,715 to Voudouris, U.S. Pat. No. 5,971,753 to Heiser, and U.S. Pat. No. 6,733,286 to Abels et al.

In SPEED System™ sold by Strite Industries, each bracket comprises a permanently mounted spring ligating member movable on the body between a slot open position for insertion and removal of the arch wire, and a slot closed position for retention of the arch wire in the slot. The spring ligating member is mounted to contact the arch wire in the closed position to provide a mutual interaction of the archwire and spring ligating member. See, http://www.speedsystem.com/HTML/the speed appliance/how speed works /01 understanding speed.html, the contents of which are incorporated herein by reference. Examples of patents disclosing such brackets are U.S. Pat. Nos. 3,772,787; 4,248,588; 4,492,573; 5,586,882; 5,630,716; and 5,906,486, the contents of which are incorporated herein by reference.

Another type of self-locking bracket is the In-Ovation® bracket sold by GAC International Inc. of Bohemia, N.Y. In its marketing materials, GAC indicates the bracket “can be passive for leveling and aligning, expressive where control is realized and free-sliding is maintained, or active for fast, optimal finishing.” See, e.g., the “In-Ovation C Doctor Brochure” entitled “In-Ovation®C The self-ligation system of choice” or the “In-Ovation R Doctor Brochure” entitled “In-Ovation®R The self-ligation system of choice” published by GAC International Inc., the contents of which are incorporated herein by reference.

However, in both the SPEED System™ and the In-Ovation® bracket, the full depth of the archwire slot (the depth necessary to completely contain a full sized archwire) is infringed upon by the spring clip or ligating member in the closed position. For example, a bracket having a 0.018″ archwire slot would require a depth of at least 0.026″ to completely contain a 0.018″×0.025″ archwire; a bracket having a 0.022″ archwire slot would require a depth of at least 0.029″ to completely contain a 0.022″×0.028″ archwire. The depth of the archwire slot in the 0.018″ and 0.022″ brackets of the SPEED System™ and the In-Ovation® system are not fully 0.026″ and 0.029″, respectively, since the spring clip or ligating member imfringes upon the slot area in the closed position. Therefore, to use brackets of the SPEED System™ and the In-Ovation® system as passive appliances, it is necessary to use archwires substantially smaller than those having horizontal depths of 0.025″ and 0.029″.

### BRIEF SUMMARY OF THE INVENTION

An orthodontic bracket includes a bracket body having a mesial-distally extending archwire slot opening to the labial surface portion, and a mesial-distally extending groove provided adjacent the archwire slot in a portion of the bracket body labially and occlusally of the archwire slot, the groove opening in a gingival direction. A spring clip of resilient material has labial and lingual portions in embracing sliding engagement with corresponding labial and lingual surface portions of the body, the spring clip being movable on the bracket body between an open position in which the archwire slot is open to the labial surface portion and a closed position in which the archwire slot is closed by the spring clip to the labial surface portion. The labial portion of the spring clip terminates in a free end that, in the closed position, is retained in the groove in the bracket body. The groove substantially prevents movement of the spring clip in the labial direction when in the closed position and is provided in relation to the archwire slot such that, when an archwire is provided in the archwire slot and is in contact with a lingual surface of the archwire slot, the spring clip is not in contact with the archwire.

Of course, the orientation of the bracket can be reversed.

### BRIEF DESCRIPTION OF THE SEVERAL VIEWS OF DRAWINGS

The present invention can be better understood with reference to the accompanying figures in which:

FIG. 1 is a perspective view of a the bracket of the present invention;

FIG. 2 is an enlarged schematic view of a portion of the bracket, including an archwire locked therein, with the spring clip in the closed position;

FIG. 3 is a perspective view of a the bracket without the spring clip and archwire showing an embodiment of the present invention in which the archwire slot has mesially-distally extending extensions;

FIG. 4 is a schematic side view of the bracket showing the clip in the open position in solid lines and in the closed position in broken lines;

FIGS. 5A-5C are schematic views showing use of the bracket of the present invention with an uprighting spring;

FIGS. 6A-6D are schematic views showing enlarged archwire slots according to an alternative embodiment of the present invention; and

FIG. 7 is a schematic view showing a variation of the shape of the bracket of the present invention.

### DETAILED DESCRIPTION OF THE INVENTION

The present invention can be better understood with reference to the accompanying figures showing various embodiments of the self-locking orthodontic bracket of the present invention. While the accompanying figures show and this description describes some embodiments of the invention, the invention is not limited thereto. One skilled in the art will understand that numerous variations and modifications are possible without departing from the spirit and scope of the invention defined by the following claim(s).

The present specification uses the terms “occlusal,” “gingival,” “labial,” “lingual,” “mesial,” “distal” and “mesial-distal” to refer to directions known in the orthodontic art. These terms, whether or not modified by the word “substantially,” are intended to include variations from these directions in which the brackets may be aligned by an orthodontist in an orthodontic treatment.

Applicant has found that it is desirable to provide a self-locking bracket similar to that of the SPEED System™ sold by Strite Industries but in which the spring clip does not infringe upon the full depth of the archwire slot.

The self-locking orthodontic bracket of the present invention is an improvement of the SPEED System™ manufactured by Strite Industries of Canada. The portion of the bracket upon which the spring clip rides would be similar but the bracket of the present invention has a spring clip that would have less tendency to curve inwardly and impinge upon the archwire space, thereby reducing the friction on an archwire. The upper part of the spring clip passively feeds into a receiving cut-out in the upper wall of the archwire slot.

When in a closed position, the archwire slot dimensions should be sufficiently free to preclude any infringement of the spring clip upon a 0.021″×0.025″ archwire. Free space should be in the area of 0.022″×0.028″ in order to reduce friction on the archwire.

On the face of the spring clip, pressed decorations can be provided for decorative effect. The spring clips can be colored (by ion deposition or similar surface additive) and/or gold plated also for decorative effect. The spring clip can also be made of clear or colored plastic type material.

A ball or mushroom post can be provided on the bracket body.

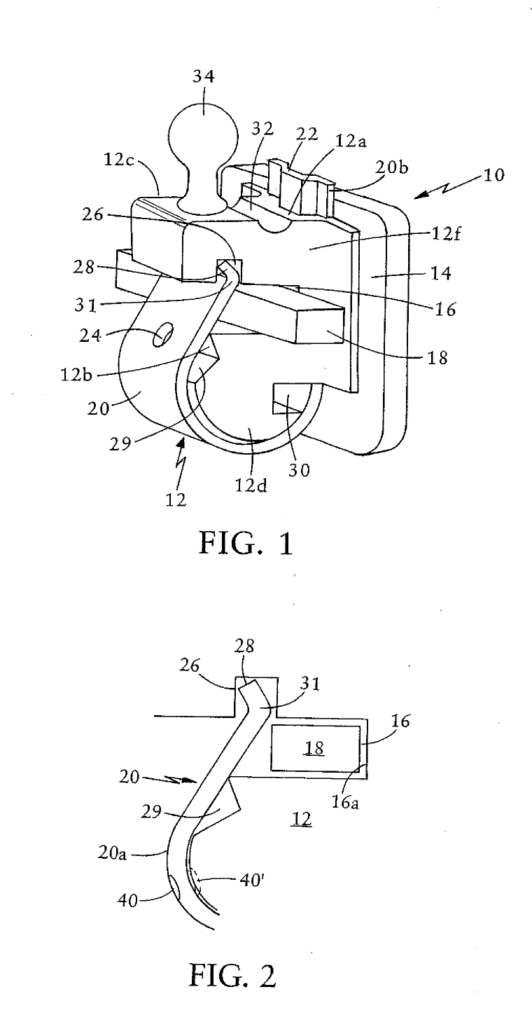

As shown in FIGS. 1-4, the bracket 10 of the present invention includes a bracket body 12 that can be attached to a pad 14 that is bonded to a tooth in use. By way of example only, the bracket body 12 is shown to have lingual 12a, labial 12b, gingival 12c, occlusal 12d, distal 12e and mesial 12f surface portions. Of course, the orientation of the bracket can be reversed. The bracket body 12 includes an archwire slot 16 extending mesial-distally and opening to the labial surface portion of the bracket body 12. An archwire 18 is shown in the archwire slot 16 in FIGS. 1 and 2.

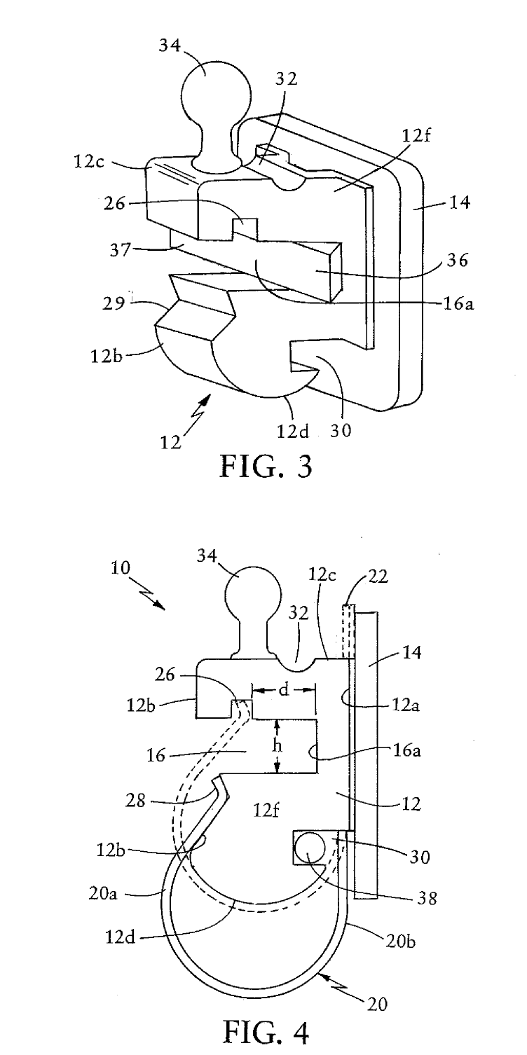

A spring clip 20 of resilient material having labial 20a and lingual 20b portions in embracing sliding engagement with corresponding labial 12b and lingual 12a surface portions of the bracket body 12. The spring clip 20 is movable on the bracket body 12 between an open position (shown solid lines in FIG. 4) in which the archwire slot 16 is open to the labial surface portion and a closed position (shown in FIGS. 1 and 3 and in broken lines in FIG. 4) in which the archwire slot 16 is closed by the spring clip 20 to the labial surface portion. The spring clip can be opened by pushing (down in this example) on free end 22 of lingual side 20b of the spring clip 20. Alternatively, the spring clip 20 can be opened by inserting a pointed tool into hole 24 and pushing (down in this example).

As shown in FIGS. 1-4, the bracket body 12 includes a mesial-distally extending groove 26 provided adjacent the archwire slot 16 in a portion of the bracket body 12 labially and gingivally of the archwire slot 16, the groove opening in an occlusal direction. As best seen in FIGS. 1 and 2, the labial portion 20a of the spring clip 20 terminates in a free end 28 that, in the closed position, is retained in the groove 26 in the bracket body 12. The groove 26 substantially prevents movement of the spring clip 20 in the labial direction when in the closed position. The groove 26 is provided in relation to the archwire slot 16 such that, when an archwire 18 is provided in the archwire slot 16 and is in contact with a lingual surface 16a of the archwire slot 16, the spring clip 20 is not in contact with the archwire 18.

For example, when the archwire slot 16 has a height h (see FIG. 4) in the occlusal-gingival direction of 0.019″, it has a depth d of at least 0.026″ such that the occlusally facing opening of the groove 26 is spaced at least 0.026″ from the lingual surface 16a of the archwire slot 16.

In another example, when the archwire slot 16 has a height h in the occlusal-gingival direction of 0.023″, it has a depth d of at least 0.029″ such that the occlusally facing opening of the groove 26 is spaced at least 0.029″ from the lingual surface 16a of the archwire slot 16.

To assist in keeping the clip 20 in the open position (see FIG. 2), the bracket body may have an indentation 40′ and the clip may have a dimple 40. Alternatively, the clip may have an indentation and the bracket body may have a dimple. As another mechanism for keeping the clip 20 in the open position (see FIGS. 1, 2 and especially FIG. 4, which shows the clip, in solid lines, in the open position and, in dashed lines, in the closed position), the bracket body may have an indentation 29 and the clip 20 may have a correspondingly shaped bend 31 (see, FIG. 2).

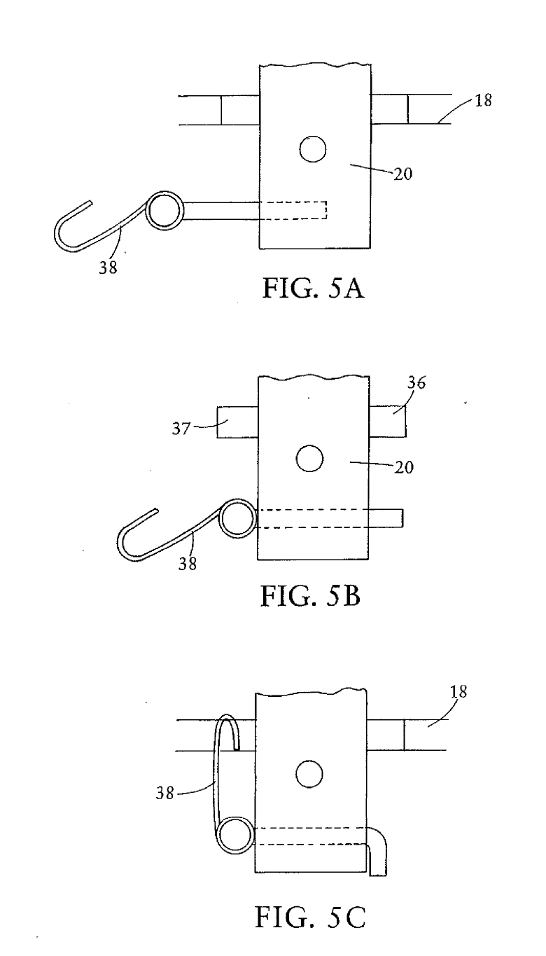

Since it is advantageous to have both the self locking and elastomeric or steel ligature methods of arch wire fixation, the bracket body also has slots 30, 32 for optional use of the bracket 10 with ligature wires or elastomerics to hold the archwire 18 in the arch wire slot 16 in place of or in addition to the spring clip or to provide additional rotation to the tooth. The slot 30 can be large enough to hold an uprighting spring 38 as shown in FIG. 4, e.g., an 0.014″ uprighting spring. See, also, FIGS. 5A-5C. The figures are not to scale and the size of the slots 30, 32 corresponds to sizes as would be known to those skilled in the art.

The bracket body 12 may include extensions 36, 37 of the lingual surface 16a of the archwire slot 16 extending mesially and distally of the bracket body as shown in FIG. 3. The extensions 36, 37 assist in providing more rotation ability. For example, if the width of the base 12 (in the mesiodistal direction) is in the range of 0.07-0.15 in., the extensions 36, 37 can each have a length, i.e., the length it extends beyond the bracket base 12, of, e.g., 0.05-0.08 in., e.g., 1/16 in. Of course, other sizes can be used as would be apparent to those skilled in the art based on this disclosure. In any case, this embodiment allows for increasing the rotational effect without increasing the width of the bracket base or allows to decrease the width of the bracket base 12 without reducing the rotational effect.

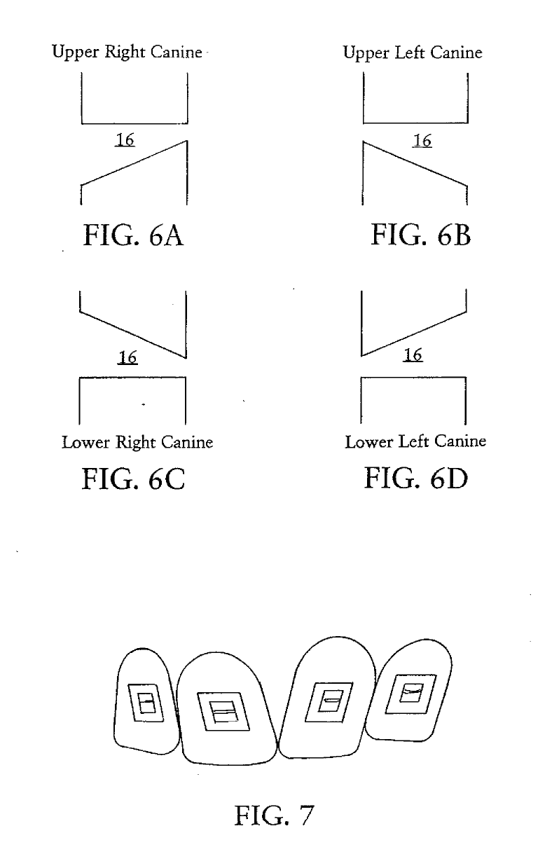

As shown in FIGS. 6A-6D, the archwire slot 16 can be enlarged in a portion of its occlusal or gingival surface to allow crowns of teeth, e.g., canine teeth, to tip distally.

A ball or mushroom post 34 can also be provided on the bracket body 12.

The bracket body 12 can also have a slot (not shown) close to the lingual side 12a extending in the occlusal-gingival direction that can be used for ligature wire.

As shown in FIG. 7, the bracket body 12 and/or the pad 14 can have a rhomboid shape to better match the shape of the tooth to which it is to be applied.

While the accompanying figure shows and this description describe some embodiments of the invention, the invention is not limited thereto. One skilled in the art will understand that numerous variations and modifications are possible without departing from the spirit and scope of the invention defined by the following claim(s).

I claim:

1. An orthodontic bracket comprising:
a bracket body having lingual, labial, gingival, occlusal, distal and mesial surface portions, having a mesial-distally extending archwire slot opening to the labial surface portion, and a mesial-distally extending groove provided adjacent the archwire slot in a portion of the bracket body labially and gingivally of the archwire slot, the groove opening in an occlusal direction; and
a spring clip of resilient material having labial and lingual portions in embracing sliding engagement with corresponding labial and lingual surface portions of the body, the spring clip being movable on the bracket body between an open position in which the archwire slot is open to the labial surface portion and a closed position in which the archwire slot is closed by the spring clip to the labial surface portion, the labial portion of the spring clip terminating in a free end that, in the closed position, is retained in the groove in the bracket body,
wherein the groove substantially prevents movement of the spring clip in the labial direction when in the closed position and wherein the groove is provided in relation to the archwire slot such that, when an archwire is provided in the archwire slot and is in contact with a lingual surface of the archwire slot, the spring clip is not in contact with the archwire.

2. The orthodontic bracket according to claim 1, wherein the archwire slot has a height in the occlusal-gingival direction of 0.019″ and a depth of at least 0.026″ such that the occlusally facing opening of the groove is spaced at least 0.026″ from the lingual surface of the archwire slot.

3. The orthodontic bracket according to claim 1, wherein the archwire slot has a height in the occlusal-gingival direction of 0.023″ and a depth of at least 0.029″ such that the occlusally facing opening of the groove is spaced at least 0.029″ from the lingual surface of the archwire slot.

4. The orthodontic bracket according to claim 1, wherein the bracket body includes extensions of the surface of the archwire slot, innermost and closest to the lingual side of the bracket, extending mesially and distally of the bracket body.

5. An orthodontic bracket comprising:
a bracket body having lingual, labial, gingival, occlusal, distal and mesial surface portions, having a mesial-distally extending archwire slot opening to the labial surface portion, and a mesial-distally extending groove provided adjacent the archwire slot in a portion of the bracket body labially and occlusally of the archwire slot, the groove opening in a gingival direction; and
a spring clip of resilient material having labial and lingual portions in embracing sliding engagement with corresponding labial and lingual surface portions of the body, the spring clip being movable on the bracket body between an open position in which the archwire slot is open to the labial surface portion and a closed position in which the archwire slot is closed by the spring clip to the labial surface portion, the labial portion of the spring clip terminating in a free end that, in the closed position, is retained in the groove in the bracket body,
wherein the groove substantially prevents movement of the spring clip in the labial direction when in the closed position and wherein the groove is provided in relation to the archwire slot such that, when an archwire is provided in the archwire slot and is in contact with a lingual surface of the archwire slot, the spring clip is not in contact with the archwire.

6. The orthodontic bracket according to claim 5, wherein the archwire slot has a height in the occlusal-gingival direction of 0.019″ and a depth of at least 0.026″ such that the occlusally facing opening of the groove is spaced at least 0.026″ from the lingual surface of the archwire slot.

7. The orthodontic bracket according to claim 5, wherein the archwire slot has a height in the occlusal-gingival direction of 0.023″ and a depth of at least 0.029″ such that the occlusally facing opening of the groove is spaced at least 0.029″ from the lingual surface of the archwire slot.
